(19) United States
(12) Patent Application Publication
(10) Pub. No.: US 2007/0274886 A1
(43) Pub. Date: Nov. 29, 2007

(54) REMOVAL AND RECOVERY OF DEPOSITS FROM COAL GASIFICATION SYSTEMS

(75) Inventors: Steven Benson, Grand Forks, ND (US); Margaret Laumb, Grand Forks, ND (US)

Correspondence Address: CONLEY ROSE, P.C.;David A. Rose, P. O. BOX 3267, HOUSTON, TX, 77253-3267, US

(73) Assignee: MICROBEAM TECHNOLOGIES, INC., Grand Forks, ND (US)

(21) Appl. No.: 11/745,788

(22) Filed: May 8, 2007

Related U.S. Application Data
(60) Provisional application No. 60/746,814, filed on May 9, 2006.

(51) Int. Cl. C01G 17/00

(52) U.S. Cl. 423/89; 423/99; 423/111; 423/87

(57) ABSTRACT

Disclosed herein are methods for removing and recovering metalloids from gasification systems. Also disclosed are methods for on-line removal of deposited entrained materials from a heat exchanger unit. A method is provided for on-line removal and recovery of deposits from fossil fuel gasification systems to improve plant performance and recover a valuable metalloid. Plant performance will be improved by decreasing impedance to gas flow and decreasing downtime required to clean the gas cooling system by providing an effective method to remove deposits while the gasification system is operating. In the preferred embodiment of the method, the deposits rich in condensed metals and metalloids are captured on heat transfer surfaces within the range of temperatures of about 400° C. to about 600° C., the temperature of the heat transfer surface is cycled causing the deposit to spall from the steel surface, and the deposits are removed from the gasifier without impacting gasifier operation.

### CROSS-REFERENCE TO RELATED APPLICATIONS

This application claims benefit of U.S. provisional application Ser. No. 60/746,814 filed May 9, 2006, and entitled “Removal and Recovery of Deposits from Coal Gasification Systems,” which is hereby incorporated herein by reference in its entirety.

### STATEMENT REGARDING FEDERALLY SPONSORED RESEARCH OR DEVELOPMENT

This invention was made with United States Government support under the U.S. Department of Energy Grant No. DE-FG03-99ER82829 Abatement of Filter Corrosion and Plugging in IGCC Systems; NSF Award No. 0232416 SBIR Phase I: Feasibility of On-line Metalloid Recovery in Gasification Systems; and NSF Award No. 0422050 SBIR Phase II: Feasibility of On-line Metalloid Recovery in Gasification Systems. The United States Government has certain rights in this invention.

### BACKGROUND OF THE INVENTION

1. Field of the Invention

The present invention relates to the removal and recovery of deposits rich in germanium and other elements from fossil fuel gasification systems. In particular, a heat exchange system is placed within the synthesis or fuel gas and the valuable elements such as germanium are condensed on the heat transfer surface, allowed to accumulate, and the deposit is removed by thermally cycling the steel surface, resulting in the spalling of the deposit and capture of the materials in a lock hopper for removal from the gasifier.

2. Background of the Invention

Germanium and other metalloids may be valuable elements, e.g., for the production of microelectronics. Particularly, germanium may have the potential to out-perform silicon in future generations of microelectronic devices. Unfortunately, germanium is much less abundant than silicon. Current sources of germanium include as a by-product of metal refining and recycling. As the potential uses for germanium increase, the current supply scheme may not be able to keep pace with demand. Thus, it may be advantageous to find new previously untapped sources for germanium and other metalloids.

Additionally, current heat removal schemes for gasification effluent streams may not operate as efficiently as desired. Particularly, in fossil fuel (e.g., coal) gasification, ash deposition on heat transfer surfaces may decrease the efficient removal of heat by the heat exchanger. Thus, it would also be advantageous to increase the efficiency of gasification system heat removal.

Advantageously, it has been discovered that the ash deposits in gasification plants may contain metalloids such as germanium. Unfortunately, deposits that include significant levels of metalloids may form within specific temperature ranges and/or within heat exchange units and may cause gasification systems to run inefficiently or shut down. Disclosed herein are methods of recovering metalloids from previously untapped sources such as gasification ash deposits, and methods for increasing the efficiency of gasification heat removal.

The removal and recovery of deposits rich in condensed elements, such as germanium, from syngas or fuel gas cooling systems in coal gasification systems both improves the plant efficiency and recovers germanium. Germanium is a valuable element that is in limited supply. Germanium is currently used in the manufacture of microelectronics. The market that includes the silicon germanium (SiGe) chip is expected to accelerate to $2.7 billion/year by 2006 (Electronic Engineering Times, 2002). The rapid growth of this market is driven by the need for higher performance germanium devices. Germanium has the potential to replace silicon (Si) in microelectronics, however, germanium will remain expensive and the limited supply is insufficient to support the microelectronics industry (Meuris, 2003). Currently, germanium is supplied mainly as a by-product of metals refining and recycling. The potential to increase germanium production is limited, and some metal refining processes are discontinuing operation.

Especially desirable would be a method to remove deposits from the syngas cooling heat exchangers in coal fired gasifiers, which would both improve plant efficiency and recover deposits rich in germanium. Despite several installations of gasification systems throughout the world, and a vast base of knowledge of ash deposition in coal combustion systems, reliability problems and high operating costs due to ash deposition on heat transfer surfaces remain serious problems for integrated gasification-combined cycle (“IGCC”) systems. To be competitive with conventional combustion systems, there is a need to improve performance, reliability, and efficiency of gasification systems. Deposits including significant levels of germanium form within specific temperature ranges and can cause gasification systems to shut down.

Accordingly, there is a substantial need to improve the reliability and efficiency of gasification systems and a need to develop a new source for germanium (and other elements such as antimony and gallium). It is therefore an objective of the present invention to exploit the synergy between these two technological problems and to provide a novel and specially designed heat exchange system to concentrate and remove deposits rich in germanium, on-line, in certain sections of gasification plants to avoid cleaning outages. In addition to minimizing downtime required for cleaning, the on-line metalloid recovery (“OMR”) system described herein will enable concentration and recovery of valuable germanium-rich deposits. An important aspect of a successful OMR system would be a method to concentrate the germanium on-line, and remove it along with the rest of the deposits, thus reducing processing costs ordinarily required to recover germanium. If implemented, such an OMR system will provide a significant source of germanium that will have the potential to decrease the costs of fiber optics, infrared optics, SiGe chips, catalysts, alloys, and other materials. The broader impacts of the OMR system on communications and computer speed will be significant if large quantities of germanium, recovered at low cost, are added to the market.

Despite the advantages of germanium, its widespread use has been limited to a large extent by cost and availability. Recovery of germanium from refineries, recycling, and from coal ash are labor-intensive and expensive processes. The primary sources for germanium in the U.S. are zinc mining, recycling of components, and a minor amount from combustion byproducts. In 2002, two zinc mines in the U.S. provided germanium for refineries. The Red Dog Mine in Alaska, owned by Teck Cominco Ltd., sent zinc concentrate to Canada for germanium extraction. Pasminco Ltd. of Australia owns the Gordonsville zinc mine in Tennessee, which contains reserves of 300,000 tons of germanium and was closed in June of 2003 (Jorgensen, 2003).

### DESCRIPTION OF THE RELATED ART

Several methods for recovering germanium from collected coal flyash have been developed. However, recent work on combustion fly ash has shown that the germanium is associated with the silicate glass material (Gier et al., 2003) and is difficult to remove. The methods involve the recovery of by heating coal combustion derived fly ash. For example, methods outlined in U.S. Pat. Nos. 4,757,772, 4,757,770, 4,678,647, and 4,643,110 involve heating of fly ash in order to vaporize the germanium, subsequently capture the germanium on the surface of sand particles, and recover the germanium from the surfaces of the sand particles. U.S. Pat. No. 4,757,772 discloses condensing the vaporized material on a cold-finger, and teaches that the material could be processed to recover the condensed phases.

The bonding of ash and slag deposits for coal combustion systems has been investigated. Raask (1985) provided a review of the bonding mechanisms for combustion systems. Benson (1987) and Moza and Austin (1982) have studied ash sticking to heat transfer surfaces under combustion conditions. Tangsathitkulchai and Austin (1986) investigated sticking of aluminosilicate-based ash materials to steel surfaces under gasification atmospheres. Ash and slag deposits can be mechanically bonded to the surface. The roughness of the steel surface will increase the degree of mechanical bonding. The steel surfaces are usually rough due to interaction of ash species with the surface. Mechanical bonding is typically weak. Chemical bonding of ash particles or slag materials to steel surfaces is very strong and occurs if oxygen or sulfur species are available on the steel surface to react with the ash particles or slag materials. In combustion systems, the steel surfaces have layers that consist of corrosion products that are rich in oxygen and sulfur. Carbon steels have significant layers of oxidation and corrosion products, while stainless steels are more resistant to oxidation and corrosion. Under the reducing environments present in gasification systems, initial layers on steel are enriched in sulfides (Tangsathitkulchai and Austin, 1986). The formation of strong bonds between steel surfaces and ash particles or slag materials depends on the following:
1) Surface tension or wetting ability of the deposited material;
2) Temperature of the steel surface and the deposit;
3) Type of steel;
4) Characteristics of the steel surface or ability to form chemical bonds with deposited material; and
5) Similarity in thermal expansion coefficient between the deposit and steel surface.

Soot blowing and thermal cycling are used to remove deposits in combustion and gasification systems. In order for effective removal to occur, the bond must be broken between the deposited material and the steel surface. Soot blowing will work if the deposit is only mechanically bonded to the surface. Thermal cycling must be used in order to remove chemically bonded deposits from steel surfaces. Thermal cycling is effective only if there is dissimilarity in thermal expansion coefficients between the deposit and steel surface. In full-scale boilers, water sprays are added to the steam to control steam and heat exchanger temperature. This process is called attemperation. Attemperation sprays have the potential to change the temperature of the steel to cause shedding of the deposit (Singer, 1991).

A method to remove deposits from heat exchange surfaces in gasification systems is described by Russel et al. in U.S. Pat. No. 4,836,146, involving a rapping method to remove deposits based on heat transfer measurements. This method is focused on the use of heat transfer measurements to control the rapping frequency and removal of deposits.

Even with the level of research in the field, the conventional work is still limited by the following factors. 1. Recovery from coal based combustion methods have focused on recovery from fly ash. This is very challenging because much of the germanium is present in the aluminosilicate matrix and difficult to remove. 2. The methods involve reheating the flyash and vaporizing the materials and subsequently condensing the vaporized materials on sand or a cold finger for subsequent treatment for recovering the materials. 3. The methods have not involved an in situ method—within the combustion or gasification system—to capture and recover germanium. 4. The methods for recovering the material from the cold finger were not addressed and recovery can be a significant challenge if chemical bonding has occurred. 5. Current practices for removal of deposits from the gas-cooling region of gasifiers have not considered cycling the heat transfer surface to break the bonds between the deposit and heat transfer surface. 6. Methods for removal of deposits have not considered heat transfer materials and coatings in order to enhance removal of deposits. Thus, the past methods have not considered a method that will isolate the deposits from the gasifier in order to remove them on-line from the system without causing the gasifier to shut down.

### SUMMARY OF THE INVENTION

It is thus an object of the present invention to overcome the deficiencies of the prior art to provide a new and economical method to accumulate, remove, and recover deposits from gasification systems on-line to prevent downtime due to deposit accumulation and plugging issues in gasification systems.

Embodiments of the current invention relate to the removal and recovery of metalloids from gasification effluent streams and to the on-line removal of heat exchanger deposits from the heat exchangers of gasification systems. Particularly, some embodiments relate to the recovery of deposits rich in germanium and other metalloids from fossil fuel gasification systems. In particular, a heat exchange system may be placed within the synthesis gas or fuel gas stream from a gasification system (e.g., a coal gasification system) and metalloids such as germanium are allowed to condense and accumulate on the heat transfer surface, and the deposits may be removed by, e.g., thermally cycling the steel surface resulting in the spalling of the deposit and capturing the materials in a lock-hopper for removal from the gasifier.

An additional object of this invention is to provide an in situ method to accumulate, remove, and recover deposits rich in germanium and other valuable elements. This invention reduces the need for gasification plants to shut down to remove deposits and recover valuable byproducts such as germanium. In some embodiments, the fossil fuels fired in the gasifier may be preferably coals of all ranks, waste coal streams, petroleum coke, bitumen, and other carbon rich coals.

In some embodiments this system has application to various types of gasification systems including, without limitation, entrained gasifiers, fluidized bed gasifiers, moving bed gasifiers, fixed bed gasifiers, and other types as are known in the art.

Some embodiments of the invention comprise the production and recovery of deposits rich in elements such as germanium and antimony that are used in the manufacture of fiber optics, infrared optics, silicon-germanium electronic chips (SiGe), alloys, and catalysts.

In some preferred embodiments, the invention is comprised of a method to accumulate and remove deposits that alleviates the need to shut the gasifier down due to plugging of heat exchange regions of the gasifier. Accordingly, certain embodiments of the invention are based on the selection of optimum metal/alloy materials of construction that minimize chemical bonding of the condensed material to the heat transfer surface, that have a difference in thermal expansion coefficients from the condensed material, have a resistance to chemical attack, and retain structural integrity during thermal cycling.

In some preferred embodiments, the invention involves placement of the heat exchanger system in a region of the gasifier where the condensation of valuable elements occurs. The placement allows for the ability to concentrate certain elements such as germanium and antimony since they condense over a specific temperature region in the gasification system. The heat exchanger would be operated within a temperature zone that would allow for maximum condensation of the valuable elements. The operation could be tailored to maximize condensation of preferred valuable components.

As will be described below in more detail below, the present invention thus provides several advantages over previously known techniques, which include condensation of valuable elements in situ, methods of deposit removal, and improvements in plant efficiency.

### BRIEF DESCRIPTION OF THE DRAWINGS

For a more detailed description of the preferred embodiment of the present invention, reference will now be made to the accompanying drawings, wherein:

FIG. 1 is a relative volatility of minor and trace elements in gasification systems;

FIG. 2 is a placement of the heat exchange system in a commercial gasification system;

FIG. 3 is ash transport and deposition mechanisms;

FIG. 4 is a laboratory apparatus for testing condensation and removal;

FIG. 5 shows details of condensation probe with coupon used for testing;

FIG. 6 is a diagram of sticking test used to determine best steel;

FIG. 7 is expansion coefficients for germanium metals and metals/alloys;

FIG. 8 is an adhesive force for germanium rich materials on selected steel coupons;

FIG. 9 shows scanning electron images of steel and germanium pellet interaction during sticking tests;

FIG. 10 shows a coupon weight gain versus gas temperature during condensation testing in a simulated gasification atmosphere on type 304 stainless steel;

FIG. 11 is backscattered electron images of condensed materials at four selected temperatures;

FIG. 12 is a backscattered electron image of germanium rich layer on surface of coupon exposed to gases at 395° C.; and

FIG. 13 is a schematic drawing of a process in accordance with embodiments of the present invention.

### DETAILED DESCRIPTION OF THE PREFERRED EMBODIMENTS

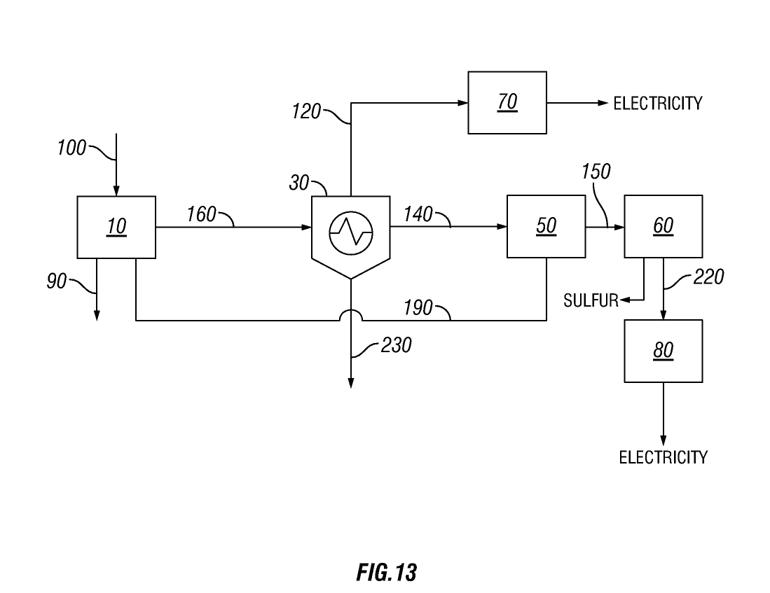

Referring now to the embodiments of FIG. 13, there is shown a gasifier 10, a syngas cooler/metalloid recovery unit 30, hot gas filtration 50, a fuel gas cleanup vessel 60, a gas turbine 80, and a steam turbine 70. In operation, a fossil fuel (e.g., coal), oxygen, and steam enter gasifier 10 via inlet stream 100. The coal is gasified to produce synthesis gas (a mixture of CO and H₂) in gasifier 10. The synthesis gas is fed via stream 160 to syngas cooler/metalloid recovery unit 30. Solid waste exits gasifier 10 via waste stream 90. In syngas cooler/metalloid recovery unit 30, the synthesis gas is cooled and entrained materials agglomerate and condense onto the heat exchange unit where they are recovered. The recovered solids are collected via recovery stream 230. Recovery stream 230 may then be sent to further extract or recover the metalloid from the entrained material. The steam generated by the cooling and metalloid recovery may then be sent via stream 120 to steam turbine 70 where electricity may be generated.

From syngas cooler/metalloid recovery unit 30, the synthesis gas is then sent via stream 140 to hot gas filtration 50 where entrained charcoal is removed. The filtered charcoal is then recycled to gasifier 10 via recycle stream 190. The filtered synthesis gas is then passed via stream 150 to fuel gas cleanup vessel 60 where it is desulfurized. The desulfurized synthesis gas may then be passed via stream 220 to gas turbine 80 where electricity may be generated.

### Particle Transport Mechanisms

Germanium may be present in many U.S. coals at levels up to 819 ppm. During gasification, the germanium vaporizes and may remain in the vapor phase until it condenses at approximately 430° C. Ash species, including inorganic vapors, liquids, and solids, may be entrained in the bulk gas flow within the combustion or gasification system and have the potential to produce deposits. In order for deposits to form, the ash species must first be transported to and retained at the deposition site or heat transfer surface. The transport of the particles to a heat transfer surface depends upon the properties of the ash species (i.e. physical state and size) and system conditions such as gas velocity, gas flow patterns, and temperature. Vapor phase species and small particles (<1 micron) may be transported to the heat transfer surfaces by diffusion mechanisms. These particles may be enriched in species that were volatilized in the flame (e.g., germanium). The vapor phase materials may condense in the stagnant boundary layer next to the heat transfer surface. Another small particle transport mechanism may be thermophoresis. Thermophoresis is a transport force that is produced as a result of a local temperature gradient from hot to cold. The thermophoresis mechanism may be important for particles less than 10 microns. Larger particles (e.g., greater than about 5 to 10 microns) may be transported to heat transfer surfaces due to inertial impaction. The larger particles may impact a surface if they have enough inertia to allow them to leave the gas streamlines such as gas moving around a tube. The smaller particles may have a tendency to follow the gas streamlines around the heat exchange tubes because the drag forces on the particles may be sufficient to keep them in the flow stream. A factor that may influence the inertial impaction mechanism is the velocity and direction of the gas flow. Eddy impaction may also be an important transport mechanism to consider because it may cause accumulation of particles on the back sides of tubes. Eddy impaction acts on particles intermediate in size between those that inertially impact and those susceptible to diffusion and thermophoresis. These particles are too small to impact on the front side of the tube, but have sufficient inertia to impact on the backside of tubes as a result of turbulent eddies. The size of these particles may usually be less than about 10 microns. The particle size of the ash being transported through the system may have a great effect on the accumulation of ash particles on heat transfer surfaces.

### Deposit Adhesion And Growth

In some embodiments, the metalloid recovery unit will operate on-line. That is, the metalloid recovery unit will operate in such a manner that it is not necessary to shut down the gasifier to recover the metalloid rich condensate from the metalloid recovery unit. By way of example only, syngas cooler 20 may comprise a series of heat exchange tube within which a cooling liquid is circulated.

The heat exchange tubes may preferably be manufactured from various types of steel or other metal alloys. For example, Type 304 stainless steel, Type 410 stainless steel, Type 405 stainless steel, or Haynes alloy HR160 (available from Haynes International, Inc., Kokomo, Ind.) may preferably be used, as may other alloys known to those skilled in the art. Different heat exchange tube materials may have different properties regarding the condensation of materials comprising metalloids. For example, some metals may maintain primarily mechanical bonds with the metalloid rich condensate cake (as opposed to primarily chemical bonds).

The adhesion and growth of ash deposits on heat-transfer surfaces may also depend upon the ability of the deposited ash particles to form strong bonds with the heat-transfer surface. Ash and slag deposits can be mechanically bonded to the surface. The roughness of the steel surface may increase the degree of mechanical bonding. The steel surfaces may be rough due to interaction of ash species with the surface. Chemical bonding of ash particles or slag materials to steel surfaces may be very strong and occur if oxygen or sulfur species are available on the steel surface to react with the ash particles or slag materials. In combustion systems, the steel surfaces may have layers that consist of corrosion products that are rich in oxygen and sulfur. Carbon steels may have significant layers of oxidation and corrosion products, while stainless steels may be more resistant to oxidation and corrosion.

The condensate cake may be removed by thermal shock by temperature cycling (e.g., changing the temperature quickly by about 10-15° C.) combined with soot blowing or water lancing. In this process, the heat exchange tube is thermally shocked and the difference in coefficient of thermal expansion between the condensate and the beat exchange tube metal may cause the condensate to spall and become loose. In this respect, it may be advantageous to choose metals which have a high coefficient of thermal expansion such that greater spalling occurs. Soot-blowing may then be used to knock off the loose condensate that has not already fallen off. The condensate may then be collected in a lock-hopper system which is isolated from the gasification process such that the gasification process is not interrupted.

Other methods of removing cake condensate from the heat exchange equipment may be acoustic methods (e.g., U.S. Pat. No. 4,836,146 to Russel et al.), or rapping methods to produce vibration.

In determining the heat exchange tube materials, one consideration is the temperature to which the tube may be heated before the metalloids become chemically bonded to the surface of the heat exchange tubes. These chemical bonds may be hard to break, making metalloid recovery more difficult (or impossible). Thus, metals which have little or no chemical affinity for the desired metalloids (e.g., germanium) may be more desirable than those which have a high chemical affinity for the desired metalloid. Additionally, metals which resist corrosion under reactor conditions may also be desirable.

Some embodiments may preferably comprise a method to accumulate and remove deposits that alleviates the need to shut the gasifier down due to plugging of heat exchange regions of the gasifier. Accordingly, certain embodiments of the invention are based on the selection of optimum metal/alloy materials of construction that minimize chemical bonding of the condensed material to the heat transfer surface, that have a difference in thermal expansion coefficients from the condensed material, have a resistance to chemical attack, and retain structural integrity during thermal cycling.

Other embodiments may preferably involve placement of the heat exchanger system in a region of the gasifier where the condensation of valuable elements occurs. The placement allows for the ability to concentrate certain elements such as germanium and antimony since they condense over a specific temperature region in the gasification system. The heat exchanger would preferably be operated within a temperature zone that would allow for maximum condensation of the desired elements. The operation could be tailored to maximize condensation of preferred desired components. The gas may preferably be cooled to temperatures between about 300° C. and about 900° C.; alternatively between about 390° C. and about 600° C.; or further alternatively, between about 450° C. and about 525° C.

As used herein, the term “metalloid” shall include Zn, Cd, Hg, B, Al, Ga, In, Tl, Si, Ge, Sn, P, As, Sb, Te, Po, Pb, Ti, Cu, Bi, Ni, and At.

### Mechanism

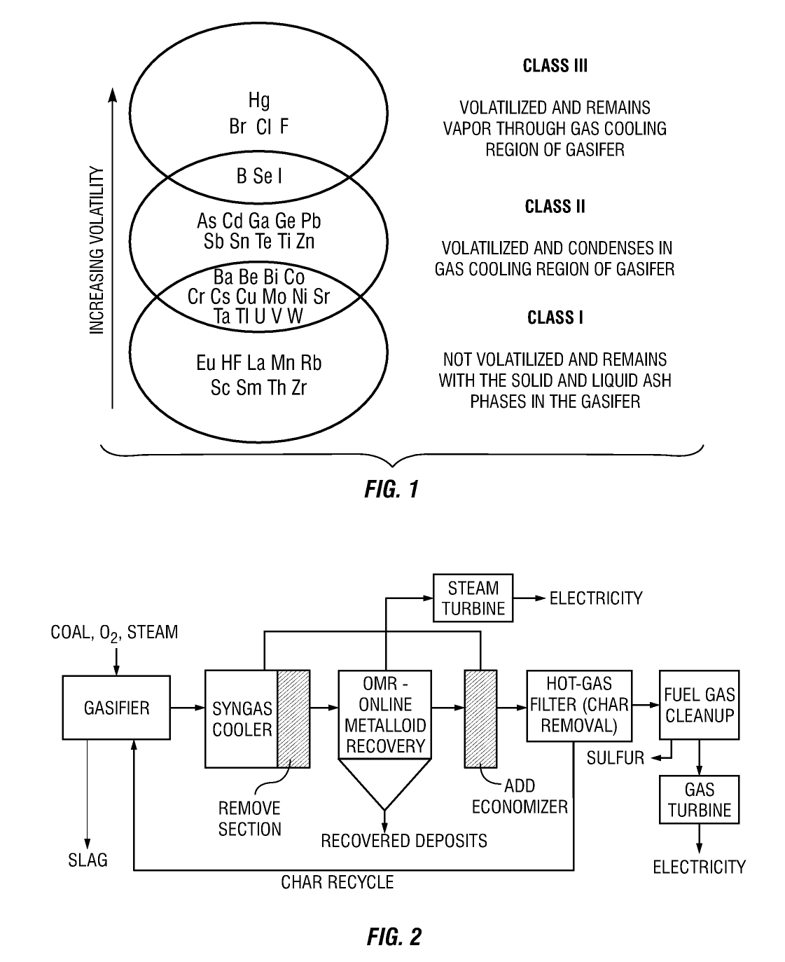

This invention is based on the fact that certain inorganic components in coal vaporize upon gasification and then condense out of the gas stream at select temperatures. The general behavior of selected inorganic components is shown in FIG. 1. The placement of specially designed heat exchange surface in the temperature region where these species condense, will concentrate these components as illustrated in FIG. 2.

### Trace Elements In Coal And Transformations During Gasification

Germanium is present in many U.S. coals, and at levels that have been measured up to 819 ppm (Swaine, 1990; Valkovic, 1983). During gasification, the germanium vaporizes and remains in the vapor phase until it condenses at approximately 430° C. (Frandsen et al., 1994; Kalfadelis and Magee, 1977). Upon condensation, vapor phase germanium species form small particles and are transported to the heat transfer surface with other entrained particles by diffusion, thermophoresis, and inertial impaction (Benson et al., 1993). Components that stick and form deposits consist of condensed vapor phase materials with minor amounts of entrained ash particles. The germanium-rich deposits were found to form strong bonds with the tube surface and could not be removed and recovered during operation in existing gasification plants equipped with conventional heat exchangers for gas cooling.

The behavior of trace elements during coal combustion has been extensively examined. Much of the work has focused on emissions from conventional pulverized coal-fired combustion systems. Erickson and others (1998) found that the transformations of trace elements in gasification systems initially parallel those in combustion, but upon gas cooling, reduced phases such as sulfides, chlorides, fluorides, and other oxygen-deficient species dominate. Some species become reduced to metallic form.

Associations, levels, and volatilities of some trace elements in coal are shown in Table 1. Germanium and antimony are distributed between organic and sulfide forms, while arsenic, lead, zinc, and cadmium are found in inorganic and sulfide associations. Germanium may also be associated with clay minerals (Swaine, 1990 and Jennings, 2002). The volatility of the elements is based on experimental evidence concerning the fate of the elements in combustion and gasification systems. FIG. 1 illustrates the classes of volatility exhibited by elements in combustion systems (Clark and Sloss, 1992) and was modified to based on behavior in gasification systems. The elements found in the deposits on heat exchangers and filters are Class IIa (described below) elements. These elements volatilize during the initial stages of gasification and upon gas cooling, condense on heat exchangers and hot gas filters in the gasifier.

TABLE 1
Associations, concentrations, and volatilities of trace elements of interest
for coals worldwide.

| Element | Association¹ | Conc., ppm² | Volatility, Class³ |
|---|---|---|---|
| Ge | Organic, sulfide | 0.5-1000 | IIa |
| As | Inorganic, sulfide | 0.5-80 | IIa |
| Cd | Inorganic, sulfide | 0.1-3 | IIa |
| Sb | Organic, sulfide | 0.05-10 | IIa |
| Pb | Inorganic, sulfide | 2-80 | IIa |
| Zn | Inorganic, sulfide | 5-300 | IIa |

¹Primary associations of the elements in the coal (Swaine, 1990, Gluskoter and others, 1977).
²Range found in coals (Swaine, 1990; Clark and Sloss, 1992, Jennings, 2002).
³Volatility of elements: Class I - do not vaporize upon gasfication, Class II - vaporize during gasification but condense in the gas cooling region (a - most volatile, b - intermediate volatility, c - least volatile of Class II), Class III - vaporize upon gasification and remain in vapor phase throughout the system (Meij, 1994, Clark and Sloss, 1992).

Equilibrium thermodynamic calculations have been performed on these elements to determine their equilibrium distribution as a function of temperature under gasification conditions (Frandsen et al., 1994; Erickson et al., 1998; Kalfadelis and Magee, 1977). Results indicated the following trends for gasification systems:
Germanium—under reducing conditions (O/C=0.6) GeO₂ (crystal [Cr], liquid [1]) is stable up to 700 K (427° C. or 800° F.). At about 800 K (527° C. or 980° F.), the form of Ge changes to GeS (g) and is gradually converted to GeO (g) up to 2000 K (1727° C. or 3140° F.).
Arsenic—under reducing conditions (O/C=0.6) As₂S₂ (cr, l) is stable up to 550 K (277° C. or 498° F.), Between 550 K and 700 K (427° C. or 800° F.), As₄ (g) is the major stable form of arsenic. Above 700 K, the most abundant stable form of As is AsO (g). Between 550 and 950 K (677° C. or 1250° F.), minor amounts of As₂ (g) and AsH3 (g) are formed.
Cadmium—under reducing conditions (O/C=0.6) CdS (cr) is stable up to 650 K (377° C. or 710° F.). Above 650 K only Cd (g) is formed.
Antimony—under reducing conditions, only SbS (g) occurs.
Lead—under reducing conditions (O/C=0.6) PbS (cr, l) is stable up to 860 K (587° C. or 1088° F.). Above 860 K PbS (g) and Pb (g) are stable. If Cl is present, PbCl₂ (cr, l) is stable up to 400 K.
Zinc—under reducing conditions ZnS (cr) is stable up to 850 K (577° C. or 1070° F.). Above 850 K, Zn (g) forms.
   Many of the above species condense to form liquid or solid phases at about 700 K (427° C. or 800° F.).

### Ash Deposit Formation In Coal Combustion And Gasification Systems

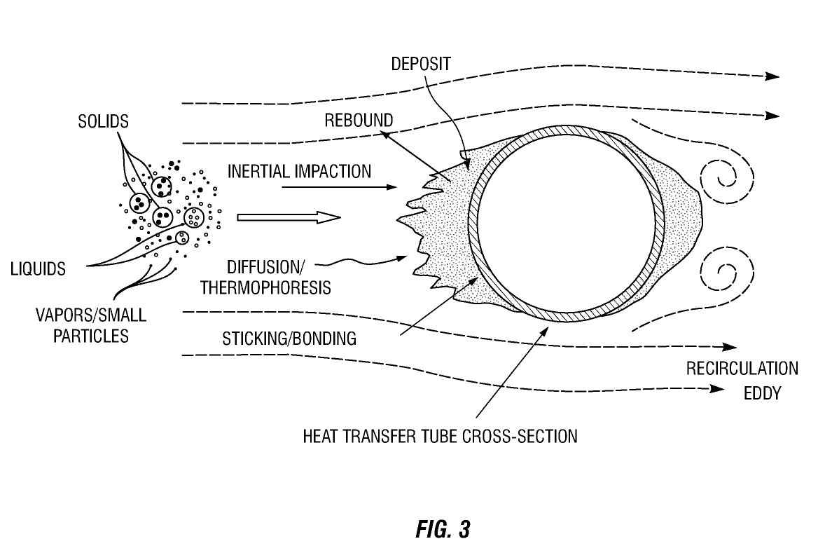

Ash species, including inorganic vapors, liquids, and solids, are entrained in the bulk gas flow within the combustion or gasification system and have the potential to produce deposits. For deposits to form, the ash species must first be transported to, and retained at, the deposition site or heat transfer surface. The transport of the particles to a heat transfer surface depends upon the properties of the ash species (i.e. physical state and size) and system conditions such as gas velocity, gas flow patterns, and temperature. The ash transport mechanisms are illustrated in FIG. 3. FIG. 3 illustrates the transport mechanisms for a tube in cross-flow as may be found in the gas cooling region of a gasifier. Vapor phase species and small (<1 micron) particles are transported to the heat transfer surfaces by diffusion mechanisms. These particles are usually enriched in species that were volatilized in the flame. The vapor phase materials may condense in the stagnant boundary layer next to the heat transfer surface. Another small particle transport mechanism is thermophoresis. Thermophoresis is a transport force that is produced as a result of a local temperature gradient from hot to cold. The thermophoresis mechanism is important for particles less than 10 microns.

Larger particles, usually larger than the 5 to 10 micron size range, are transported to heat transfer surfaces due to inertial impaction. The larger particles may impact a surface if they have enough inertia to allow them to leave the gas streamlines such as gas moving around a tube. The smaller particles will have a tendency to follow the gas streamlines because the drag forces on the particles are sufficient to keep them in the flow stream. The primary factor that influences the inertial impaction mechanism is the velocity and direction of the gas flow. Eddy impaction is also an important transport mechanism to consider because it can cause accumulation of particles on the back (downstream, leeward) sides/surfaces of tubes. Eddy impaction acts on particles intermediate in size between those that inertially impact and those susceptible to diffusion and thermophoresis. These particles are too small to impact on the front side of the tube, but have sufficient inertia to impact on the backside of tubes as a result of turbulent eddies. The size of these particles is usually less than 10 microns. Therefore, the particle size of the ash being transported through the system has a great effect on the accumulation of ash particles on heat transfer surfaces.

The adhesion and growth of ash deposits on heat-transfer surfaces depends upon the ability of the deposited ash particles to form strong bonds with the heat-transfer surface. The bonding of ash and slag deposits for coal combustion systems has been investigated extensively; however, little work has been conducted on ash deposit growth in gasification systems. Raask (1985) provided a review of the bonding mechanisms for combustion systems. Benson (1987) and Moza and Austin (1982) have studied ash sticking to heat transfer surfaces under combustion conditions. Tangsathitkulchai and Austin (1986) investigated sticking of ash materials to steel surfaces under gasification atmospheres. Ash and slag deposits can be mechanically bonded to the surface. The roughness of the steel surface will increase the degree of mechanical bonding. The steel surfaces are usually rough due to interaction of ash species with the surface. Mechanical bonding is typically weak. Chemical bonding of ash particles or slag materials to steel surfaces is very strong and occurs if oxygen or sulfur species are available on the steel surface to react with the ash particles or slag materials. In combustion systems, the steel surfaces have layers that consist of corrosion products that are rich in oxygen and sulfur. Carbon steels have significant layers of oxidation and corrosion products, while stainless steels are more resistant to oxidation and corrosion. Under the reducing environments present in gasification systems, initial layers on steel are enriched in sulfides (Tangsathitkulchai and Austin, 1986). The formation of strong bonds between steel surfaces and ash particles or slag materials depends on the following:
Surface tension or wetting ability of the deposited material
Temperature of the steel surface and the deposit
Type of steel
Characteristics of the steel surface or ability to form chemical bonds with deposited material
Similarity in thermal expansion coefficient between the deposit and steel surface

Soot blowing and thermal cycling are used to remove deposits in combustion and gasification systems. In order for effective removal to occur, the bond must be broken between the deposited material and the steel surface. Soot blowing will work if the deposit is only mechanically bonded to the surface. Thermal cycling must be used in order to remove chemically bonded deposits from steel surfaces. Thermal cycling is effective only if there is dissimilarity in thermal expansion coefficients between the deposit and steel surface. In full-scale boilers, water sprays are added to the steam to control steam and heat exchanger temperature. This process is called attemperation. Attemperation sprays have the potential to change the temperature of the steel to cause shedding of the deposit (Singer, 1991).

### Deposit Removal And Germanium/Other Element Removal

Deposits may preferably be removed and recovered from the gas cooling region using this invention. The heat exchange system may preferably operate at temperatures between 300° C. and 900° C. It is also preferable that the materials used in construction of the heat exchanger be of alloy or metal that is corrosion-resistant, resulting in weak mechanical and chemical bonds between the deposits and the tubes that can be easily broken through thermal cycling. During the high-heat phase of the thermal cycle, the deposits will be accumulated on the heat exchange tubes. When the tubes are cooled, the steel contracts over a specific temperature range, breaking the bond between the condensed germanium and the steel, resulting in spalling the deposit from the steel. In addition, the OMR concept was developed for on-line removal and recovery of deposits. The OMR recovers deposits through selection of heat exchange material to minimize sticking, and by careful control of the temperature cycling of the heat exchange tubes in the gas-cooling section of a gasifier, removes the deposit.

Referring now to FIG. 13, the OMR system, shows a retrofit to existing facilities. The system employs an advanced heat exchange system using alloys that form weak bonds with deposits. The heat exchanger can be thermally cycled to break bonds between tube surfaces and deposits, breaking the bond with the deposits. The deposits will be shed and collected in a lock hopper below the heat exchanger. The lock hopper, isolated from the gasifier process, can be emptied on-line without interrupting operation of the gasification system.

Controlled thermal cycling specifically designed to concentrate and remove deposits on-line in certain sections of the plant to avoid cleaning outages is not used in IGCC or conventional power plants. Some existing plants use uncontrolled methods of thermal cycling, by dropping the load and cooling the entire unit, to attempt to shed deposits. Most power plants use sootblowers and water lances to remove deposits. Uncontrolled thermal cycling and sootblowing work only when deposits are weakly bonded to the tubes, and have several pitfalls: reduction in capacity and efficiency, possible tube damage from frequent sootblowing, and degradation of the tube due to chemical bonding. The OMR system can significantly increase the efficiency by decreasing impedance to gas flow and decreasing downtime of the gasification system.

In addition to minimizing downtime required for cleaning, the OMR system will enable concentration and recovery of valuable germanium-rich deposits. An important aspect of the OMR system is the method to concentrate the germanium on-line, and remove it along with the rest of the deposits, thus reducing processing costs ordinarily required to recover germanium.

### Apparatus For Determining Optimum Conditions For Concentrating/Removing Deposits

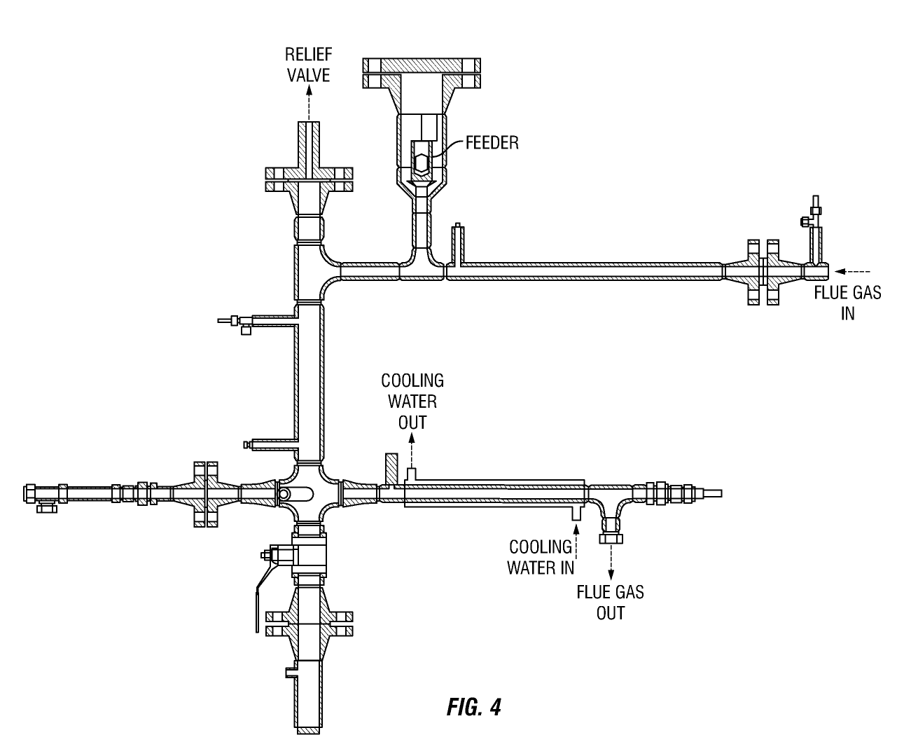

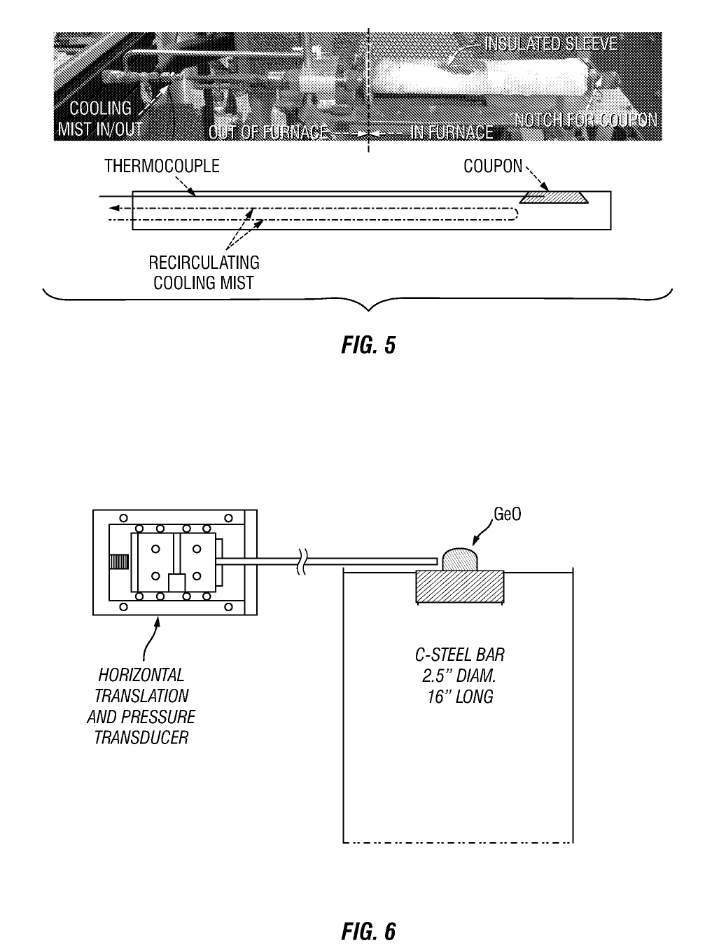

Referring now to FIG. 4, there is illustrated a test apparatus for determining the temperatures of condensation, cycling temperatures, and removal efficiencies of condensed species such as germanium. This system has the ability to test various coupons of materials to determine bonding between condensed phases and steel surface. FIG. 5 shows the water mist-cooled condensation probe used to accumulate the vaporized species. A removable sample coupon is placed at the tip of the probe. Cooling water mist recirculates through the probe near the surface, controlling the temperature of the sample coupon. By changing the flow rate of the water mist through the probe, the coupon temperature is controlled and materials may be preferentially condensed onto the probe and then removed by rapidly increasing the flow of cooling water mist, resulting in a rapid decrease in surface temperature, and shedding of the condensed materials through differences in thermal expansion characteristics.

Strength of deposit adhesion is measured using the apparatus shown in FIG. 6. A vertically-oriented sample holder made of solid steel material is positioned inside a vertically-oriented tube furnace. The sample coupon is placed in a depression at the top surface of the sample holder. The surface temperature of the coupon is controlled through thermal conductivity through the sample holder. A thermocouple placed within a small hole in the center of the coupon monitors temperature of the center of the coupon. A pellet of material is placed on top of the coupon and melted in place with a torch. After allowing the coupon to cool to the set temperature, a horizontal translation device is used to push the pellet from the surface of the coupon. The pressure required to break the bond between the pellet and the coupon surface is measured with the pressure transducer in the horizontal translation device.

### EXAMPLES

### Example 1

### Sticking Temperatures And Steel

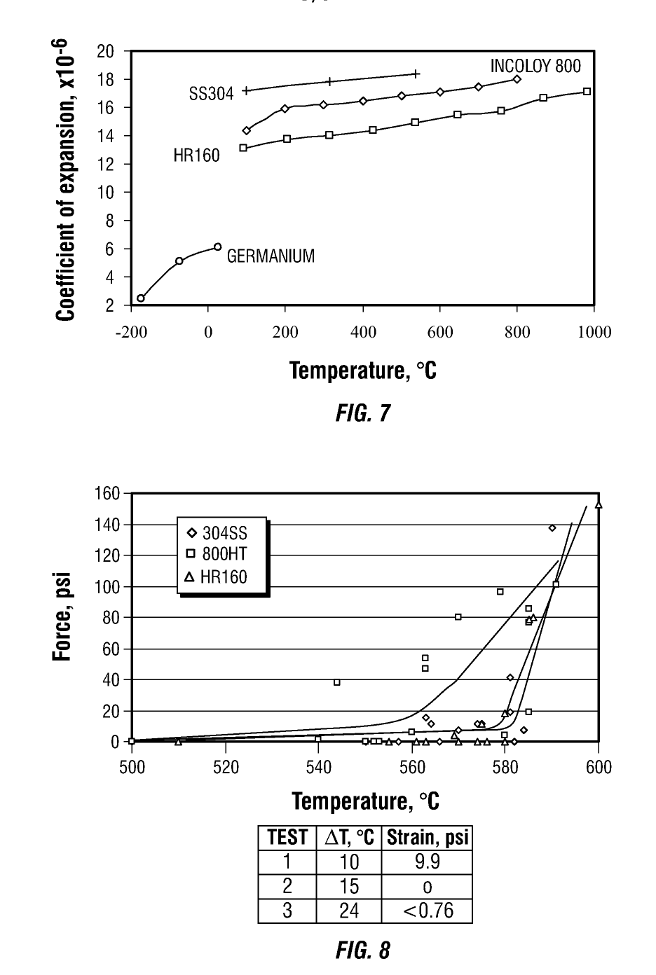

FIG. 7 illustrates the thermal expansion coefficients for germanium metal and several steels and alloys. The thermal expansion coefficient changes slightly with temperature. Thermal expansion for germanium metal is small compared to that for any of the steel or alloys. At room temperature, the thermal expansion coefficient for germanium is about 6×10⁻¹ in/in; the thermal expansion coefficient for Haynes alloy HR160 is about 13×10⁻⁶ in/in.

FIG. 8 shows the results of the sticking tests performed for a germanium oxide pellet on three alloys: Type 304 stainless steel, Incoloy 800HT, and Haynes HR160. At 600° C. the force required to break the bonds between the pellet and the surfaces was very high. Based on the strength of the bonds between the pellet and the metal surface, and on the thermal expansion coefficients of the metals used, the bonds for each metal type became weak at different temperatures. Both type 304 stainless steel and HR160 had bonds that were broken easily at about 580° C. Pellets were not easily removed from Incoloy 800HT until the temperature of the metal had fallen to about 560° C.

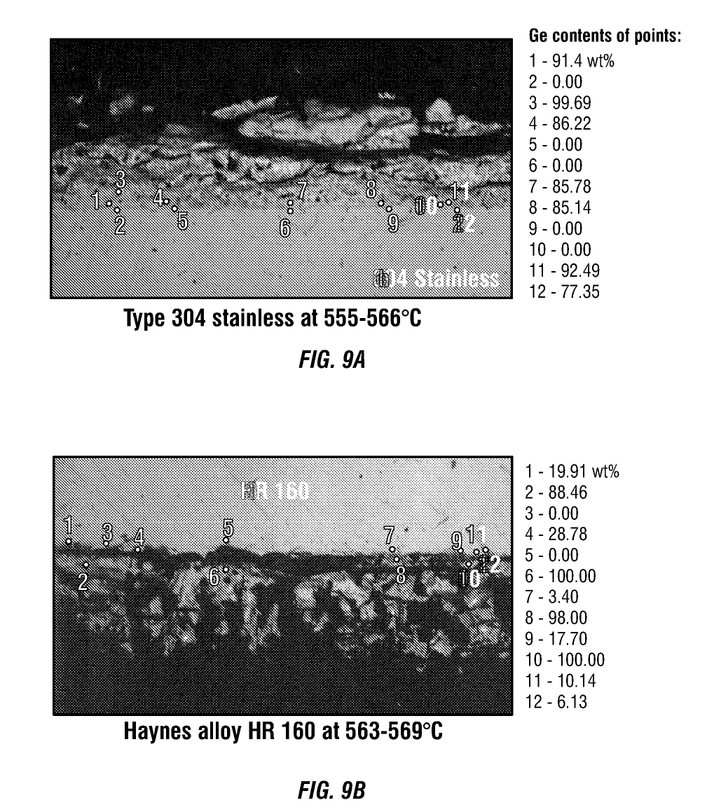

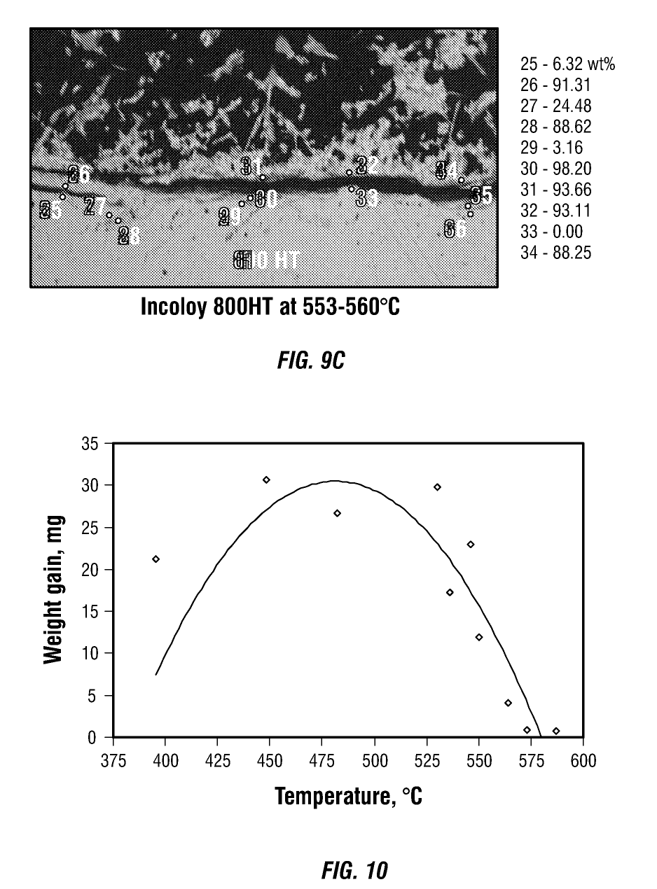

FIG. 9 shows the degree of interaction between the molten pellets and the steel surfaces. For Type 304 stainless and HR160, which both required small temperature changes to spall the pellet material from the surfaces, no chemical interaction between the pellet and the metal was observed. Therefore the bonding that occurred between the pellet and the metal surfaces was strictly mechanical. The 800HT had some incorporation of the germanium material into the surface of the alloy, indicating chemical bonding between the pellet and the metal surface had occurred.

### Example 2

### Optimum Condensation Temperature

Work to determine the optimum surface temperature for condensation of vaporized germanium was performed; the results of the work are shown in FIG. 10. Surface temperatures between 390° C. and 600° C. at atmospheric pressure were evaluated. At atmospheric conditions, optimum condensation of vaporized germanium occurs at steel surface temperatures between 450° C. and 525° C.

### Example 3

### Composition of Deposited Materials And Thickness of Layers

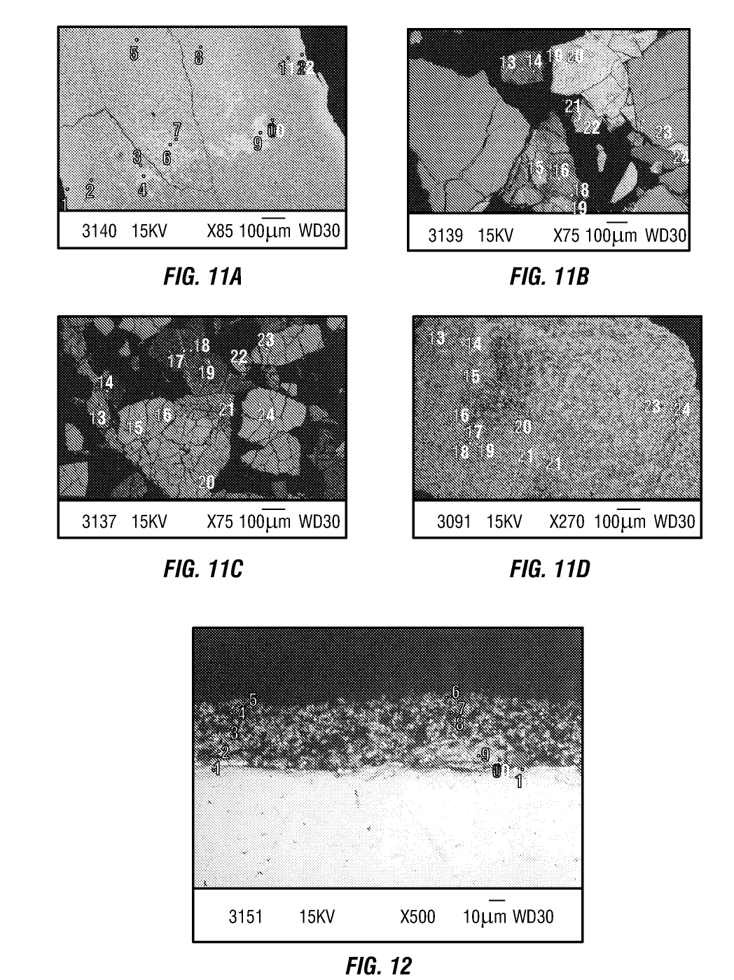

FIG. 11 shows scanning electron micrographs of germanium-rich material deposited onto the surface of sample coupons during condensation testing. The table below shows average compositions of the deposited materials.

| FIG. # | Point # | Description | Al | Si | P | S | Cl | K | Ti | Cr | Fe | Ni | Cu | Ge | O |
|---|---|---|---|---|---|---|---|---|---|---|---|---|---|---|---|
| A | 1 | Light edge | 0.00 | 0.34 | 0.00 | 24.42 | 0.00 | 0.00 | 0.00 | 0.00 | 14.89 | 2.86 | 0.00 | 57.49 | 0.00 |
| 03-140 | 2 | Dark center | 0.00 | 0.49 | 0.62 | 19.35 | 0.00 | 0.00 | 0.00 | 0.00 | 4.53 | 0.89 | 0.00 | 65.05 | 9.07 |
| | 3 | Dark area | 0.00 | 0.31 | 0.00 | 25.50 | 0.00 | 0.00 | 0.00 | 0.00 | 10.81 | 1.48 | 1.61 | 60.29 | 0.00 |
| | 4 | Light area | 1.18 | 0.77 | 1.34 | 26.90 | 0.00 | 0.24 | 0.48 | 0.00 | 16.61 | 5.89 | 1.39 | 45.19 | 0.00 |
| | 5 | Dk/lt mottled area | 0.00 | 0.31 | 1.20 | 27.43 | 0.00 | 0.00 | 0.00 | 0.00 | 13.79 | 3.42 | 0.00 | 53.85 | 0.00 |
| | 6 | Light area | 0.00 | 0.48 | 0.00 | 25.23 | 0.00 | 0.00 | 0.00 | 0.64 | 9.59 | 3.97 | 1.67 | 58.40 | 0.00 |
| | 7 | Dark area | 0.00 | 0.00 | 1.10 | 21.23 | 0.00 | 0.00 | 0.00 | 0.41 | 5.17 | 1.35 | 1.11 | 69.63 | 0.00 |
| | 8 | Dk/lt mottled area | 0.00 | 0.00 | 0.45 | 23.65 | 0.00 | 0.00 | 0.00 | 0.00 | 11.82 | 2.02 | 0.00 | 62.05 | 0.00 |
| | 9 | Light area | 0.00 | 0.00 | 1.71 | 24.78 | 0.00 | 0.00 | 0.40 | 0.00 | 12.02 | 4.80 | 0.00 | 47.15 | 9.14 |
| | 10 | Dark area | 0.00 | 0.00 | 0.61 | 19.28 | 0.00 | 0.00 | 0.00 | 0.00 | 3.58 | 1.02 | 0.00 | 68.10 | 7.40 |
| | 11 | Dark area | 0.00 | 0.00 | 0.91 | 15.81 | 0.00 | 0.00 | 0.00 | 0.00 | 1.58 | 0.00 | 0.00 | 66.72 | 14.98 |
| | 12 | Light edge | 0.00 | 0.00 | 0.00 | 22.99 | 0.00 | 0.00 | 0.00 | 0.00 | 9.09 | 3.97 | 0.00 | 52.13 | 11.82 |
| | | Average: | 0.10 | 0.23 | 0.66 | 23.05 | 0.00 | 0.02 | 0.07 | 0.09 | 9.46 | 2.64 | 0.48 | 58.84 | 4.37 |
| B | 13 | Light porous area | 0.00 | 0.78 | 0.00 | 16.86 | 0.00 | 0.68 | 0.00 | 2.53 | 42.88 | 0.00 | 0.00 | 0.00 | 36.27 |
| 03-139 | 14 | Dark porous area | 0.00 | 0.00 | 0.00 | 19.35 | 0.00 | 0.00 | 0.00 | 3.03 | 45.26 | 0.00 | 0.00 | 0.00 | 32.36 |
| | 15 | Light area | 0.00 | 0.81 | 2.34 | 25.81 | 0.00 | 0.00 | 0.00 | 6.42 | 25.17 | 12.78 | 0.00 | 26.67 | 0.00 |
| | 16 | Medium area | 1.08 | 0.00 | 1.67 | 30.40 | 0.00 | 0.00 | 0.00 | 2.30 | 40.30 | 0.00 | 0.00 | 4.89 | 19.37 |
| | 17 | Light area | 0.00 | 0.00 | 0.00 | 17.45 | 0.00 | 0.42 | 0.00 | 4.15 | 24.54 | 14.86 | 0.00 | 26.24 | 12.34 |
| | 18 | Dark area | 0.00 | 0.00 | 0.00 | 21.43 | 0.00 | 0.00 | 0.00 | 2.63 | 56.68 | 3.69 | 0.00 | 0.00 | 15.57 |
| | 19 | Medium edge | 0.00 | 0.57 | 0.95 | 7.82 | 0.00 | 0.00 | 0.00 | 2.69 | 17.01 | 14.91 | 1.63 | 22.60 | 31.82 |
| | 20 | Light area | 0.00 | 0.00 | 0.00 | 13.21 | 0.00 | 1.31 | 0.00 | 6.76 | 14.83 | 24.76 | 0.00 | 39.14 | 0.00 |
| | 21 | Medium particle | 0.00 | 14.02 | 0.00 | 25.76 | 0.00 | 0.00 | 0.00 | 0.00 | 60.21 | 0.00 | 0.00 | 0.00 | 0.00 |
| | 22 | Medium area | 0.00 | 0.00 | 0.94 | 18.27 | 0.00 | 0.00 | 0.00 | 2.81 | 43.47 | 2.31 | 0.00 | 4.11 | 28.09 |
| | 23 | Medium area | 0.00 | 0.55 | 0.60 | 1.11 | 0.00 | 0.00 | 0.00 | 0.00 | 43.56 | 2.62 | 0.00 | 0.00 | 51.55 |
| | 24 | Light particle | 0.00 | 0.56 | 0.66 | 10.51 | 0.00 | 0.00 | 0.00 | 6.88 | 9.79 | 17.51 | 0.00 | 39.30 | 14.79 |
| | | Average: | 0.09 | 1.44 | 0.60 | 17.33 | 0.00 | 0.20 | 0.00 | 3.35 | 35.31 | 7.79 | 0.14 | 13.58 | 20.18 |
| C | 13 | Long particle | 0.00 | 1.52 | 1.31 | 32.21 | 0.00 | 0.00 | 0.00 | 0.00 | 38.11 | 8.05 | 3.99 | 14.83 | 0.00 |
| 03-137 | 14 | Light streak | 0.00 | 0.00 | 0.00 | 25.45 | 0.00 | 0.00 | 0.00 | 11.33 | 39.17 | 1.87 | 0.00 | 9.37 | 12.81 |
| | 15 | Light area | 0.00 | 0.00 | 0.00 | 30.68 | 0.00 | 0.00 | 0.00 | 0.00 | 64.87 | 0.00 | 0.00 | 4.45 | 0.00 |
| | 16 | Light area | 0.00 | 0.36 | 0.00 | 27.06 | 0.00 | 0.38 | 0.00 | 0.61 | 48.49 | 0.00 | 1.48 | 7.66 | 13.96 |
| | 17 | Light streak | 0.89 | 0.00 | 1.41 | 32.84 | 0.00 | 0.00 | 0.00 | 5.77 | 50.90 | 2.64 | 0.00 | 5.55 | 0.00 |
| | 18 | Park particle | 0.00 | 0.00 | 0.00 | 32.07 | 0.00 | 0.00 | 0.00 | 6.65 | 51.64 | 0.00 | 3.42 | 6.22 | 0.00 |
| | 19 | Light area | 0.00 | 0.00 | 0.00 | 32.68 | 0.00 | 0.49 | 0.00 | 4.78 | 56.03 | 2.17 | 0.00 | 3.85 | 0.00 |
| | 20 | Light particle | 1.39 | 0.44 | 2.10 | 20.93 | 0.00 | 0.00 | 0.00 | 0.00 | 23.04 | 0.00 | 0.00 | 22.76 | 29.34 |
| | 21 | Porous edge | 0.00 | 0.00 | 0.00 | 29.21 | 0.00 | 0.00 | 0.00 | 4.04 | 51.62 | 1.76 | 0.00 | 0.00 | 13.37 |
| | 22 | Light area | 1.15 | 0.62 | 0.00 | 31.75 | 0.00 | 0.00 | 0.00 | 0.00 | 48.26 | 2.74 | 0.00 | 15.49 | 0.00 |
| | 23 | Porous particle | 0.00 | 0.00 | 0.00 | 37.27 | 0.00 | 0.00 | 0.00 | 0.00 | 55.71 | 0.00 | 0.00 | 7.02 | 0.00 |
| | 24 | Light particle | 1.54 | 0.72 | 0.00 | 23.26 | 0.00 | 0.00 | 0.00 | 0.00 | 69.99 | 2.50 | 0.00 | 1.99 | 0.00 |
| | | Average: | 0.41 | 0.30 | 0.40 | 29.62 | 0.00 | 0.07 | 0.00 | 2.76 | 49.82 | 1.81 | 0.74 | 8.26 | 5.79 |
| D | 13 | Dark area | 0.00 | 0.32 | 0.00 | 4.33 | 0.00 | 0.28 | 0.00 | 0.92 | 86.58 | 1.36 | 0.00 | 0.00 | 6.21 |
| 03-091 | 14 | Light area | 0.00 | 0.00 | 0.00 | 3.75 | 0.40 | 0.00 | 0.00 | 0.00 | 91.96 | 3.89 | 0.00 | 0.00 | 0.00 |
| | 15 | Dark overall | 0.00 | 0.00 | 0.00 | 7.04 | 0.00 | 0.00 | 0.00 | 0.00 | 61.14 | 3.48 | 0.00 | 0.00 | 28.34 |
| | 16 | Dark overall | 0.00 | 0.37 | 0.70 | 11.58 | 0.00 | 0.00 | 0.00 | 0.00 | 46.81 | 0.00 | 0.00 | 0.00 | 40.54 |
| | 17 | Light area | 0.61 | 0.55 | 0.00 | 11.10 | 0.00 | 0.00 | 0.00 | 0.61 | 75.70 | 2.09 | 0.00 | 0.00 | 9.34 |
| | 18 | Light area | 0.00 | 0.00 | 0.79 | 6.75 | 0.54 | 0.00 | 0.00 | 0.00 | 47.22 | 2.94 | 0.00 | 3.48 | 38.27 |
| | 19 | Bright/light area | 0.00 | 0.00 | 0.00 | 5.89 | 0.00 | 0.00 | 0.00 | 0.00 | 87.97 | 6.14 | 0.00 | 0.00 | 0.00 |
| | 20 | Bright area | 0.00 | 0.00 | 0.00 | 7.09 | 0.00 | 0.00 | 0.00 | 0.00 | 84.80 | 4.14 | 3.97 | 0.00 | 0.00 |
| | 21 | Light area | 0.00 | 0.00 | 0.60 | 3.98 | 0.00 | 0.36 | 0.00 | 0.00 | 92.65 | 2.41 | 0.00 | 0.00 | 0.00 |
| | 22 | Overall | 0.00 | 0.00 | 0.00 | 8.29 | 0.00 | 0.00 | 0.00 | 0.00 | 43.29 | 3.19 | 0.00 | 0.00 | 45.22 |
| | 23 | Overall | 0.00 | 0.00 | 0.00 | 1.04 | 0.00 | 0.00 | 0.00 | 0.82 | 86.90 | 3.13 | 0.00 | 1.71 | 6.40 |
| | | Average: | 0.06 | 0.11 | 0.19 | 6.44 | 0.09 | 0.06 | 0.00 | 0.21 | 73.18 | 2.98 | 0.36 | 0.47 | 15.85 |

The chemical composition of numerous points was determined for each sample and the averages were used to produce FIG. 12. As temperature decreased, the level of germanium in the condensed materials increased. Sulfur was observed in the samples, but was relatively constant over the temperature range investigated. In addition, as temperature decreased and the level of germanium in the condensed materials increased, the level of iron decreased. It is likely that the level of germanium in the condensed materials is constant over the range of temperatures but that the thickness of the condensed materials increases with decreasing temperature. The electron beam penetrates into the sample surface. For a very thin condensed layer (i.e., <0.5 μm), X-rays will be produced for both elements in the condensed material, and elements present in an underlying layer (in this case, steel that has “peeled” as a result of temperature and reducing atmosphere).

Thus, the present invention includes a method to accumulate, remove, and recover deposits formed in gasification systems that comprises a heat exchanger constructed of advanced alloys (possibly with coatings) that have the ability to operate within a very precisely controlled gas temperature region, to control steel surface temperature, to cycle steel surface temperature, to spall deposits from the surface and to recover them in a hopper that can be isolated from the gasifier. The materials of construction may be based on their ability to resist corrosion as well as bond to the materials that will be accumulated. The gas temperature can be maintained within specific ranges in order to capture the materials of interest. The temperature of the steel surface may preferably be maintained at slightly above the sticking temperature for the heat transfer surface to allow for sticking of the material. The thermal expansion coefficients of the steel and the deposited material may be different. The heat transfer surface temperature can be cycled allowing for shedding of the deposited material. The material can be removed from the surface by rapping or acoustics and collected in a hopper and removed from the system.

The present invention also includes a method to accumulate materials that have vaporized during the gasification process by condensing them on cooled heat transfer surfaces. The materials that vaporize include but are not limited to Ge, As, Cd, Sb, Pb, and Zn, and these elements can be condensed on heat transfer surfaces. Of specific interest is the ability to condense and recover Ge at temperatures between 600° C. to 800° C.; and accumulating germanium on the cooled heat transfer surface with concentrations up to 60% Ge.

The present invention also includes a method to control the sticking of condensed materials to heat transfer surface. The method includes selection of alloy and surface coating to allow for minimal bonding; operation of the alloy at temperatures slightly above the sticking temperature for accumulating the vaporized components such as Ge; change or cycle the temperature of the steel to break the bonds between the heat transfer surface the deposited materials allowing it to spall from the surface; and remove the deposited materials by rapping and/or vibrating, or acoustical methods. The present invention also includes a method for recovering valuable elements from gasification synthesis gas streams

While the preferred embodiments of the invention have been disclosed herein, it will be understood that various modifications can be made to the system described herein without departing from the scope of the invention. For example, the gasification system may comprise, without limitation, entrained gasifiers, fluidized bed gasifiers, moving bed gasifiers, or fixed bed gasifiers. Without further elaboration, it is believed that one skilled in the art can, using the description herein, utilize the present invention to its fullest extent. The embodiments described herein are to be construed as illustrative and not as constraining the remainder of the disclosure in any way whatsoever. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

### REFERENCES

Annual Energy Outlook 2003; U.S. Department of Energy/Energy Information Administration; DOE/EIA-0383 (2003); 256 pp.

Annual Energy Outlook 2004; U.S. Department of Energy/Energy Information Administration; DOE/EIA-0383 (2003); 256 pp.

Benson, S. A., “Laboratory Studies of Ash Deposit Formation During the Combustion of Western U.S. Coals”, Ph.D. Thesis, The Pennsylvania State University, 1987.

Benson, S. A.; Jones, M. L.; Harb, J. N. “Ash Formation and Deposition”. In Fundamentals of Coal Combustion for Clean and Efficient Use; Smoot, D. L., Ed.; Coal Science and Technology 20 Series; Elsevier: Amsterdam, 1993; Chapter 4, pp 299-373

Benson, S. A., Katrinak, K. A., Characterization of a Germanium-Rich Gasifier Deposit, Confidential report to DESTEC Energy Inc., Microbeam Technologies Inc., Grand Forks, N. Dak., November 1997.

Benson, S. A.; Katrinak, K. A.; Laumb, J. D. “Abatement of Filter Corrosion and Plugging in IGCC Systems”; final report to the U.S. Department of Energy on grant number DE-FG03-99ER82829; Microbeam Technologies, Inc.: Grand Forks, N. Dak., 2000.

Bucca, L. Germanium Corporation of America, personal communication, 2004.

Clark, L. B., Sloss, L. L., Trace Elements—Emissions from Coal Combustion and Gasification, IEA Coal Research Rep. No. IEACR/49, 1992.

Davydov, V. I., Germanium, Transl. from Russian, Gordon and Breach, Science Publishers, New York, 1959.

Electronic Engineering Times UK, “SiGe Poised for Growth”, vol. 48, Sep. 9, 2002.

Erickson, T. A., Galbreath, K. C., Zygarlicke, C. J., Hetland, M. D., and Benson, S. A., Trace Element Emissions, Final Technical Progress Report Prepared for the Federal Energy Technology Center, DE-AC21-92MC28016, October 1998.

Fiber Optics to 2006: Products & Systems—Market Size, Market Share, Demand Forecast and Sales; The Freedonia Group, Inc; Cleveland, Ohio.

FutureGen—A sequestration and Hydrogen Research Initiative, U.S. Department of Energy, Office of Fossil Energy, February 2003.

Frandsen, F., Dam-Johansen, K., and Rasmussen, P., “Trace Elements From Combustion and Gasification of Coal—An Equilibrium Approach,” Progress in Energy and Combustion Science, vol. 20, p. 115-138, 1994.

FutureGen—A Sequestration and Hydrogen Research Initiative, U.S. Department of Energy, Office of Fossil Energy, February 2003.

Gasfication—Worldwide Use and Acceptance; Report to U.S. Department of Energy Office of Fossil Energy, National Energy Technology Laboratory, and Gasification Technologies Council by SFA Pacific, Mountain View, Calif., 1999.

Gier, R.; Johnstone, J; Tishmack, J.; Fly ash from coal combustion: waste material or valuable source of Germanium?; Presented at Geological Society of America 2003 Seattle Annual Meeting (Nov. 2-5, 2003).

Gluskoter, H. J., Ruch, R. R., Miller, W. G., Cahill, R. A., Dreher, G. B., Kuhn, J. K., Trace Elements in Coal: Occurrence and Distribution, Ill. State Geol. Surv., Circ. 499, Urbana, 1977.

Herzog, H. J. and D. Golomb, “Carbon Capture and Storage from Fossil Fuel Use,” contribution to Encyclopedia of Energy, to be published (2004).

Increasing Coal-Fired Generation Through 2010: Challenges and Opportunities, The National Coal Council, May 2002, http://www.nationalcoalcouncil.org/Documents/May02REPORT.doc

Jorgenson, J; Germanium; U.S. Geological Survey commodity summary, January 2003.

Kalfadelis, C. D. and Magee, E. M., Ind. Eng. Chem. Fund., vol. 16, no. 4, p. 489, 1977.

Laumb, M. L.; Benson, S. A. “Feasibility of On-line Metalliod Recovery System”; final report to the National Science Foundation on SBIR Phase I award 0232416; Microbeam Technologies, Inc.: Grand Forks, N. Dak., 2003.

Laumb, M.; Benson, S. A.; Laumb, J. “Ash Behavior in Utility Boilers: A Decade of Fuel and Deposit Analyses,” Presented at the United Engineering Foundation Conference on Ash Deposition and Power Production in the 21st Century, Snowbird, Utah, Oct. 28-Nov. 2, 2001.

Meij, R., “Trace Element Behavior in Coal-Fired Power Plants,” Fuel Proc. Technol., vol. 39, p. 199-217, 1994.

Meuris, M. “High-k Strides Reopen Door to Germanium,” Electronic Engineering Times: 56, Aug. 25, 2003.

Moza, A. K. and Austin, L. G., “Studies on Deposit Formation in Pulverized Coal Combustors: Part 1. Results on the Wetting and Adherence of Synthetic Coal Ash Drops on Steel”, Fuel, vol. 60, p. 1057-1064, 1981.

Moza, A. K. and Austin, L. G., “Studies on Slag Deposit Formation in Pulverized Coal Combustors: Part 3. A Preliminary Hypothesis for the Sticking Behavior of Slag Drops on Steels”, Fuel, vol. 62, p. 161-165, 1982.

Novikova S. I., Sov. Phys. Solid State 2, 1 (1960) 37-38.

Operations Guide for the Use of Additives in Utility Boilers; final report to Electric Power Research Institute on Project 1839-3; EPRI CS-5527, December 1987.

Parsons Infrastructure and Technology Group, Inc, Clean Coal Reference Plants: IGCC Texaco, Parsons, December 2001.

Parsons Infrastructure and Technology Group, Inc, The Cost of Mercury Removal in an IGCC Plant, Final Report U.S. DOE, Parsons, September 2002.

Power the Future—Elm Road Generating System Case Study; Public Service Commission of Wisconsin Department of Natural Resources; Docket Number 05-CE-130, Aug. 19, 2003.

Raask, Erich. Mineral Impurities in Coal Combustion, Hemisphere Publishing Corporation, Washington, 1985.

Singer, J. P., “Combustion, Fossil Power Systems”, Combustion Engineering Inc., Windsor, Conn., 1981.

Stiegel, G. J., and Maxwell, R. C., “Gasification Technology: The Path to Clean, Affordable Energy in the 21st Century”, Fuel Processing Technology, vol. 71, p. 79-97, 2001.

Swaine, D. J., Trace Elements in Coal, Butterworths & Co. Ltd., London, 1990.

Tangsathitkulchai, M.; Austin, L. G., Fundamental Studies of the Mechanisms of Slag Deposit Formation, Topical Technical Report Prepared for the U.S. Department of Energy, DOE/PC/70770-T9, March 1986.

Tsang, A., Global Energy, personal communication, 1999.

Tsang, A. Personal Communication, Global Energy, 2003.

Tsang, A., ConocoPhillips, personal communication, 2004.

U.S. Dept. of Energy, “The Wabash River Coal Gasification Repowering Project”, Topical Report No. 7, November 1996.

Utility Mercury Reductions Rule; U.S. Environmental Protection Agency; http://www.epa.gov/mercury/actions.htm; 2003

Valkovic, V., Trace Elements in Coal, CRC Press, Boca Raton, Fla., 1983.

The Wabash River Coal Gasification Repowering Project, U.S. Dept. of Energy Topical Report No. 7, November 1996.

We claim:

1. A method for obtaining metalloids, the method comprising:
depositing an entrained material that is in solid, liquid, or vapor phase and comprising at least one metalloid onto a heat exchanger;
removing the entrained material from the heat exchanger; and
recovering the metalloid from the entrained material.

2. The method of claim 1 wherein the metalloid is selected from the group consisting of Ge, Zn, Cd, Hg, B, Al, Ga, In, Tl, Si, Sn, P, As, Sb, Te, Po, Pb, Ti, Cu, Bi, Ni, and At.

3. The method of claim 1 wherein the gasification system is a fossil fuel gasification system.

4. The method of claim I wherein the heat exchanger operates at about 300° C. to about 900° C.

5. The method of claim 1 wherein the heat exchanger operates at about 390° C. to about 600° C.

6. The method of claim 1 wherein the heat exchanger operates at about 450° C. to about 525° C.

7. A method for cooling a gasification reactor effluent, the method comprising:
providing a heat exchanger;
depositing an entrained material portion of the effluent onto the heat exchanger,
removing the deposited entrained material from the heat exchanger without shutting down the gasification reactor.

8. The method of claim 7 wherein the entrained material comprises a metalloid and the method further comprises collecting the metalloid containing entrained material and recovering at least a portion of the metalloid.

9. The method of claim 7 wherein the entrained material comprises a metalloid selected from the group consisting of Ge, Zn, Cd, Hg, B, Al, Ga, In, Tl, Si, Sn, P, As, Sb, Te, Po, Pb, Ti, Cu, Bi, Ni, and At.

10. The method of claim 9 wherein the entrained material comprises Ge and the method further comprises collecting the Ge containing entrained material and recovering at least a portion of the Ge from the entrained material.

11. The method of claim 7 wherein the removing step comprises thermally shocking any portion of the heat exchanger.

12. The method of claim 11 wherein the removing step comprises soot-blowing at least a portion of the heat exchanger.

13. The method of claim 12 further comprising collecting the removed deposited entrained materials in a lock-hopper.

14. The method of claim 7 wherein the removing step comprises acoustical removal of the entrained material.

15. A means for collecting metalloids, the means comprising:
a means for producing a vaporized metalloid;
a means for accumulating the vaporized metalloid;
a means for recovering the accumulated metalloid.

16. The means for collecting of claim 15 wherein the means for producing comprises a gasification reactor.

17. The means for collecting of claim 15 wherein the means for accumulating comprises a heat exchange unit.

18. The means for collecting of claim 15 wherein the means for recovering comprises a means for on-line recovery of the accumulated metalloid.

19. The means for collecting of claim 18 wherein the means for on-line recovery comprises a heat exchanger and a lock-hopper, wherein the accumulated metalloid is disengaged from the heat exchanger into the lock-hopper.

20. The means for collecting of claim 15 wherein the metalloid is Ge.
